(19) United States
(12) Patent Application Publication
(10) Pub. No.: US 2021/0248435 A1
(43) Pub. Date: Aug. 12, 2021

(54) METHOD OF MANUFACTURING MULTILAYER CHIP COMPONENT

(71) Applicant: TDK CORPORATION, Tokyo (JP)

(72) Inventors: Gaku ECHIGOYA, Tokyo (JP); Hiroshi SATOU, Tokyo (JP); Keijiro ISHIDA, Tokyo (JP); Hajime KUDO, Tokyo (JP)

(73) Assignee: TDK CORPORATION, Tokyo (JP)

(21) Appl. No.: 17/166,074

(22) Filed: Feb. 3, 2021

(30) Foreign Application Priority Data
Feb. 6, 2020 (JP) 2020-018697

(51) Int. Cl. G06K 19/06; H01G 4/30; H01G 4/002; H01F 41/12

(52) U.S. Cl. CPC G06K 19/06037; H01F 41/125; H01G 4/002; H01G 4/30

(57) ABSTRACT

In a method of manufacturing a multilayer chip component according to an aspect of the present disclosure, a two-dimensional code is formed in each of green chips divided in a dividing step. In the two-dimensional code, a substrate ID identifying a laminate substrate and an individual body ID identifying an individual multilayer chip component are associated with each other. Therefore, it is possible to accurately and quickly discern which laminate substrate a multilayer chip component is manufactured from by reading the two-dimensional code of the multilayer chip component, and thus high traceability can be achieved.

### CROSS-REFERENCE TO RELATED APPLICATIONS

This application is based upon and claims the benefit of priority from Japanese Patent Application No. 2020-18697, filed on 6 Feb. 2020, the entire contents of which are incorporated herein by reference.

### TECHNICAL FIELD

The present disclosure relates to a method of manufacturing a multilayer chip component.

### BACKGROUND

Japanese Unexamined Patent Publication No. 2009-135322 (Patent Literature 1) discloses a technology for discerning a position where a defect has occurred in a green laminate by applying a mark on a surface of a green laminate which will be divided into corresponding individual green chips.

### SUMMARY

When a problem occurs in a multilayer chip component that is a finished product, if there is traceability related to a manufacturing process, it is possible to trace back to an intermediate product or a raw material, and thus it is possible to easily investigate the problem or eliminate a defective product. A mark on a green laminate related to the technology in the related art described above only discerns a position where a defect has occurred and does not contribute to traceability related to a manufacturing process.

According to the present disclosure, a method of manufacturing a multilayer chip component, in which traceability related to a manufacturing process is enhanced, is provided.

According to an aspect of the present disclosure, there is provided a method of manufacturing a multilayer chip component including a step of forming a code in each of a plurality of individual regions on a main surface of a laminate substrate, a plurality of green sheets are laminated in the laminate substrate, the code indicates at least information identifying an intermediate product in a previous stage and information identifying an individual finished product, a step of forming a plurality of green chips by dividing the laminate substrate according to each of the individual regions, and a step of making each of the green chips into a multilayer chip component as a finished product.

In the foregoing manufacturing method, a code is formed in each of the green chips which will become multilayer chip components. In the code, information identifying an intermediate product in a previous stage and information identifying an individual finished product are associated with each other. Therefore, it is possible to accurately and quickly discern which intermediate product a multilayer chip component has been manufactured from by reading the code of the multilayer chip component that is a finished product, and thus high traceability can be achieved.

In the method of manufacturing a multilayer chip component according to the aspect, after the code is formed in a green sheet constituting the main surface of the laminate substrate, the laminate substrate is obtained by laminating a plurality of green sheets including the green sheet constituting the main surface of the laminate substrate.

In the method of manufacturing a multilayer chip component according to the aspect, the information identifying an intermediate product in a previous stage may he information identifying the laminate substrate.

In the method of manufacturing a multilayer chip component according to the aspect, the code may be a two-dimensional code including a plurality of dots.

In the method of manufacturing a multilayer chip component according to the aspect, in the step of forming a code, the dots included in the code may be formed through laser processing.

### BRIEF DESCRIPTION OF THE DRAWINGS

FIG. 1 is a schematic perspective view of a multilayer chip component according to an embodiment.

FIG. 2 is a view illustrating a two-dimensional code formed on a. main surface of the multilayer chip component.

FIG. 3 is an enlarged cross-sectional view of dots included in the two-dimensional code in FIG. 2.

FIG. 4 is a flowchart illustrating a method of manufacturing a multilayer chip component according to the embodiment.

FIG. 5 is a view illustrating a step of the manufacturing method according to the embodiment.

FIG. 6 is a view illustrating another step of the manufacturing method according to the embodiment.

FIG. 7 is a cross-sectional view illustrating dots in a different form.

### DETAILED DESCRIPTION

Hereinafter, an embodiment of the present disclosure will be described in detail with reference to the accompanying drawings. In the description, the same reference signs are used for the same elements or elements having the same function, and duplicate description will he omitted.

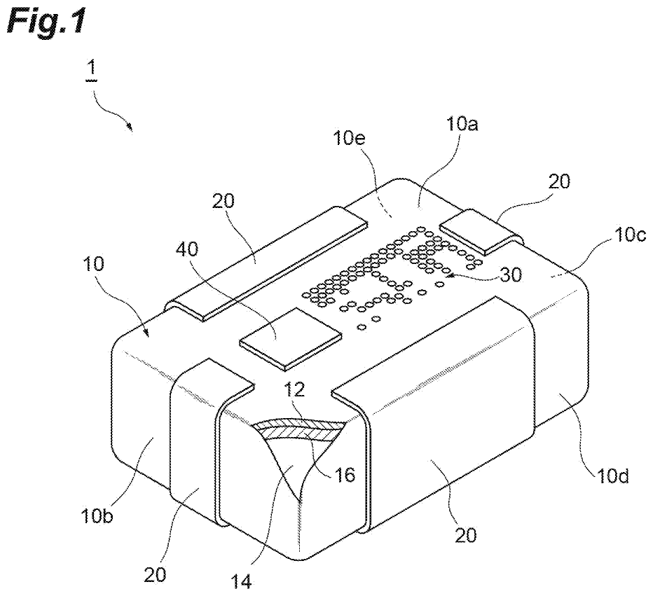

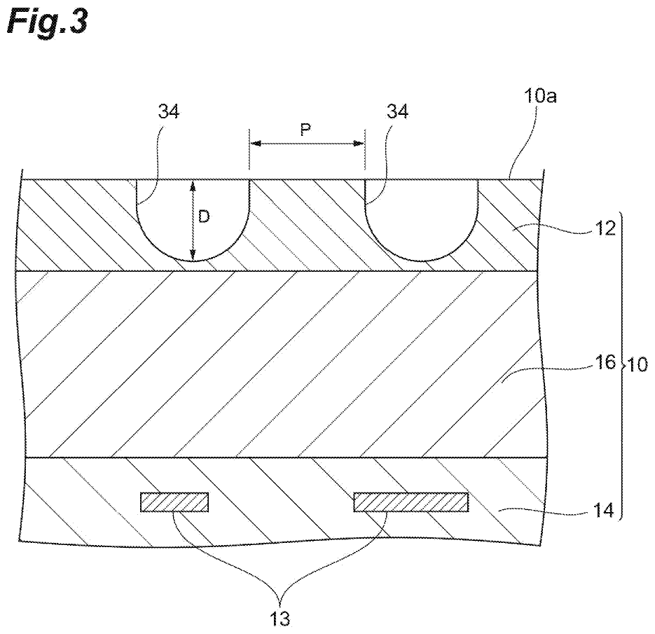

First, with reference to FIGS. 1 to 3, a configuration of a multilayer chip component 1 according to the embodiment will be described.

The multilayer chip component 1 is an electronic component including an element body 10 and a plurality of electrodes 20.

The element body 10 has a lamination structure including a plurality of glass ceramic layers, and internal electrode layers are provided in a part between the ceramic layers. For example, the glass ceramic layers contain 50 to 70 weight % of glass as a main component and contain 30 to 50 weight % of an alumina component. For example, the internal electrode layers constitute coils or capacitors or constitute filters including a coil and a capacitor. The element body 10 has substantially a rectangular parallelepiped external shape, and all corners thereof are rounded. As an example of dimensions thereof, the element body 10 has a long side length of 2.5 mm, a short side length of 2.0 mm, and a thickness of 0.9 mm. The element body 10 has an upper surface 10a (main surface), a pair of end surfaces 10b and 10c facing each other in a long side direction, and a pair of side surfaces 10d and 10e facing each other in a short side direction. The upper surface 10a of the element body 10 is constituted of a surface layer 12, and a cover layer 16 is interposed between a functioning layer 14, in which internal electrode layers 13 are provided, and the surface layer 12. The surface layer 12 has a thickness within a range of 10 to 30 μm (as an example, 20 μm), and the cover layer 16 has a thickness within a range of 30 to 50 μm (as an example, 40 μm). The cover layer 16 is designed to be thicker than the surface layer 12.

Each of the electrodes 20 is provided on a surface of the element body 10 and is connected to each of the internal electrode layers exposed to the end surfaces 10b and 10c and the side surfaces 10d and 10e of the element body 10. In the present embodiment, four electrodes 20 in total, that is, a pair of end surface electrodes 20 provided on the end surfaces 10b and 10c and a pair of side surface electrodes 20 provided on the side surfaces 10d and 10e, are provided. Each of the electrodes 20 wraps around the element body 10 to the main surface 10a side and covers a part of an outer edge region on the main surface 10a.

A two-dimensional code 30 and a direction identification mark 40 are provided in a central region on the main surface 10a of the element body 10.

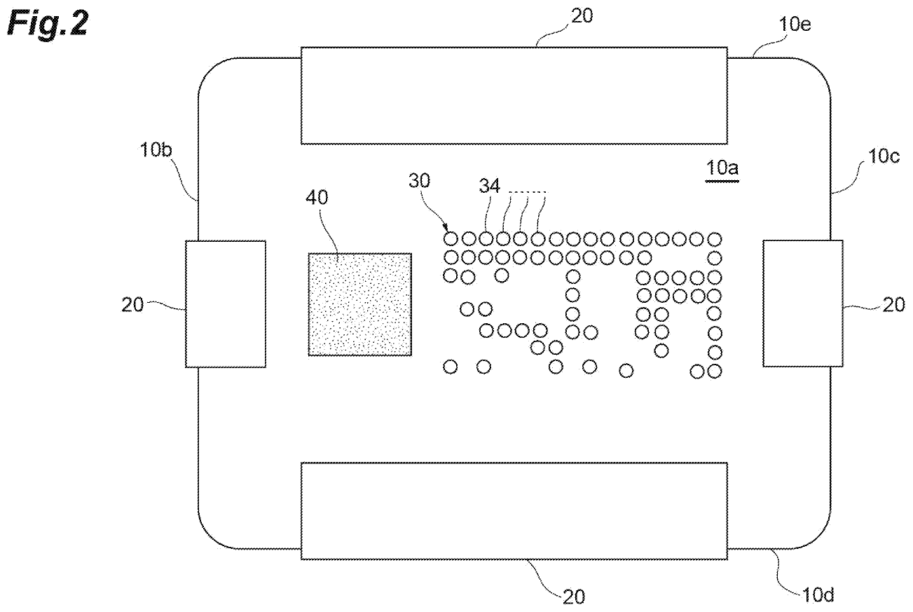

For example, the two-dimensional code 30 is a code conforming to regulations, such as a data matrix code, a QR code (registered trademark), and a micro QR code, The two-dimensional code 30 may be a matrix type or a stack type. In the present embodiment, the two-dimensional code 30 is a matrix-type data matrix code, and dots 34 are provided in parts of cells (8×16). A formation region of the two-dimensional code 30 has a rectangular shape (as an example, 1020μm×560 μm) extending in the long side direction of the element body 10. Each of the dots 34 has substantially a perfectly circular shape in a plan view and has a diameter within a range of 20 to 50 μm (as an example, 40 μm). in the two-dimensional code 30, a separation distance (that is, a pitch P) between two dots 34 adjacent to each other is within a range of 5 to 40 μm (as an example, 25 μm). As illustrated in FIG. 2, each of the dots 34 is a recess provided on the main surface 10a of the element body 10 through laser processing and has substantially a semicircular cross-sectional shape. That is, substantially no corner portions are present in a cross-sectional shape of each of the dots 34, which thereby have sufficient smoothness. Each of the dots 34 exhibits a mortar shape in a three-dimensional manner. In this application, a semicircular cross-sectional shape includes not only a semicircular shape having a central angle of 180 degrees at the center of curvature but also a semicircular shape having a central angle smaller than 180 degrees (arc shape) at the center of curvature and a semicircular shape including a straight part (U shape). Each of the dots 34 is designed to have a depth shorter than the thickness of the surface layer 12, and each of the dots 34 is adjusted such that it does not reach the cover layer 16. In addition, each of the dots 34 is designed to have a depth D shorter than the pitch P of the two-dimensional code 30 (D<P). In the present embodiment, the depth of each of the dots 34 is within a range of 5 to 30 μm (as an example, 15 μm). In the present embodiment, a color of the surface layer 12 is white, and a color of each of the dots 34 is also white.

The two-dimensional code 30 can indicate information as a plurality of digits. For example, the two-dimensional code 30 can indicate information of 22 digits in numerical characters or alphabetical characters. The information of a plurality of digits indicated by the two-dimensional code 30 includes an individual body ID that is information identifying the multilayer chip component I and a substrate ID that is information identifying a laminate substrate 54 that is an intermediate product used when the multilayer chip component 1 is manufactured.

The direction identification mark 40 is a mark for distinguishing the direction or the polarity of the multilayer chip component 1 based on the appearance thereof. The direction identification mark 40 has a square shape in a plan view and is adjacent to the two-dimensional code 30 in the long side direction of the element body 10. For example, the direction identification mark 40 is formed of metal oxide such as ZrO₂ and is adjusted to have a dark color such as black.

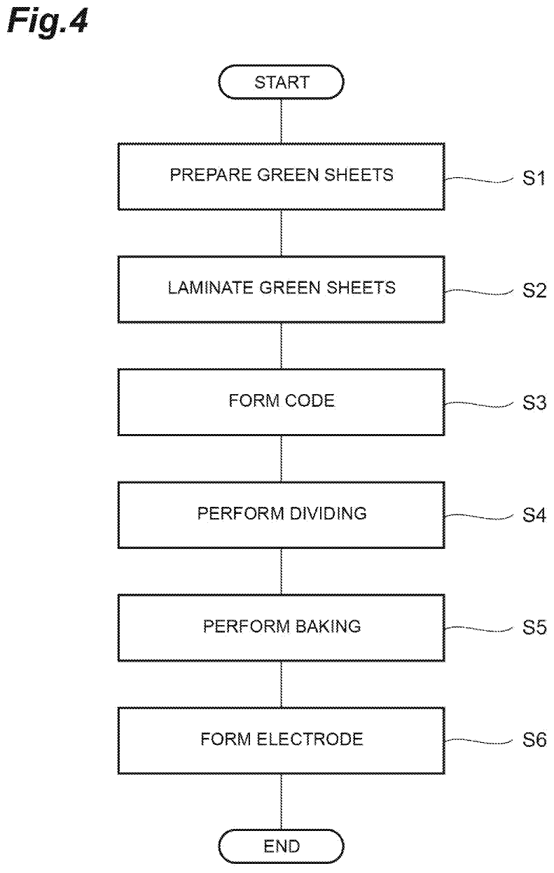

Subsequently, a procedure of manufacturing the multilayer chip component 1 described above will be described with reference to the flowchart in FIG. 4.

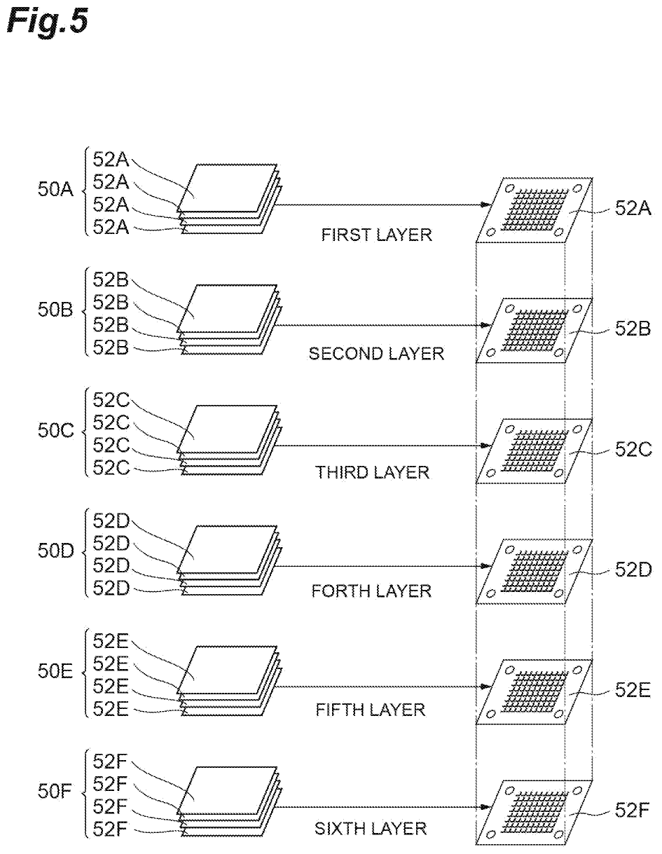

When the multilayer chip component 1 is manufactured, in Step S1, glass green sheets constituting the ceramic layers of the element body 10 are prepared. In the present embodiment, as illustrated in FIG. 5, a plurality of sheet groups 50A to 50F respectively corresponding to the ceramic layers are prepared. All the green sheets included in each of the sheet groups 50A to 50F are formed from the same sheet roll through punching. The plurality of sheet groups 50A to 50F may he formed from the same sheet roll or may be formed from different sheet rolls. Further, a pattern for a predetermined internal electrode layer is formed in each of the sheet groups 50A to 50F. For example, a pattern for an uppermost internal electrode layer is formed in green sheets 52A of the sheet group 50A. At this time, a sheet ID that is information identifying a green sheet and a code (for example, a two-dimensional code) indicating a sheet roll ID that is information identifying a sheet roll used for the green sheet may be formed in a margin region (for example, an outer edge region) of each of the green sheets 52A to 52F. In this case, it is possible to accurately and quickly discern which sheet roll a green sheet is manufactured from by reading the code, and thus high traceability can be achieved.

In Step S1, in addition to the green sheets 52A to 52F which will become the functioning layer 14, a green sheet which will become the surface layer 12 and a green sheet which will become the cover layer 16 are also prepared.

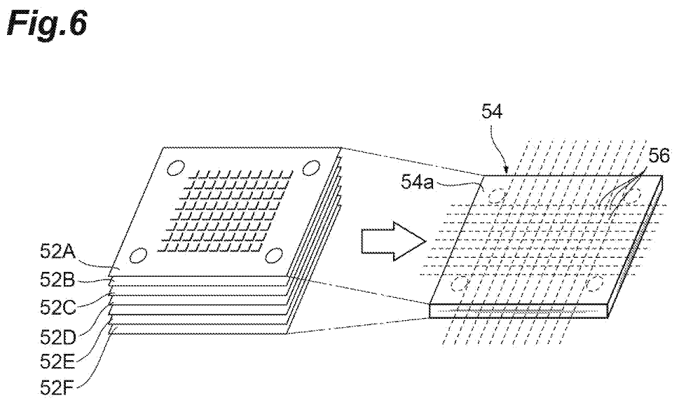

Next, in Step S2, as illustrated in FIG. 6, the green sheets 52A to 52F described above are laminated. At this time, in addition to the green sheets 52A to 52F which will become the functioning layer 14, a green sheet which will become the surface layer 12 and a green sheet which will become the cover layer 16 are also laminated. Further, pressing is performed in a lamination direction, and the laminate substrate 54 in which a plurality of green sheets are laminated can be obtained. The laminate substrate 54 is an intermediate product which will be divided into a plurality of green chips, and a plurality of individual regions 56 are arranged in a matrix shape (for example, 8 rows×10 columns).

Thereafter, in Step S3, the two-dimensional code 30 described above is formed on the laminate substrate 54. Specifically, the two-dimensional code 30 is formed in each of the plurality of individual regions 56 on a main surface 54a of the laminate substrate 54. In one laminate substrate 54, the two-dimensional code 30 formed in each of the individual regions 56 varies with each of the individual regions 56. The two-dimensional code 30 is formed before a dividing step (Step S4) and a baking step (Step S5). In Step S3, together with the two-dimensional code 30, a sputtered film which will become the direction identification mark 40 is formed after the baking step.

In Step S4 subsequent to Step S3, the laminate substrate 54 is divided into the individual regions 56, and a plurality of green chips are formed.

Moreover, in Step S5, green chips are baked, and the element body 10 of the multilayer chip component 1 is obtained. The sputtered film formed in Step S3 will become the direction identification mark 40 through baking. In the present embodiment, after Step S4, corners of the element body 10 are rounded through barrel polishing.

Last, the electrodes 20 are respectively provided on the end surfaces 10b and 10c and the side surfaces 10d and 10e of the element body 10, and the multilayer chip component 1 is thereby completed as a finished product.

In the method of manufacturing the multilayer chip component 1 described above, the two-dimensional code 30 is formed in each of the green chips divided in Step S4. The two-dimensional code 30 indicates at least the substrate ID identifying the laminate substrate 54 and the individual body ID identifying the individual multilayer chip component 1, and the substrate ID and the individual body ID are associated with each other in the two-dimensional code 30. Therefore, it is possible to accurately and quickly discern which laminate substrate 54 a multilayer chip component 1 is manufactured from by reading the two-dimensional code 30 of the multilayer chip component 1. Accordingly, high traceability can be achieved.

The two-dimensional code 30 can also be formed in advance in a green sheet which will become the surface layer 12 in addition to being formed in a form of the laminate substrate 54. That is, the two-dimensional code 30 can be formed on the main surface 54a of the laminate substrate 54 by laminating a green sheet in which the two-dimensional code 30 is formed as a green sheet which will become the surface layer 12.

An instrument able to handle the size or the like of the dots 34 can be used for reading the two-dimensional code 30, and a laser microscope can be used in the present embodiment.

The formation region of the two-dimensional code 30 is designed to have a rectangular shape extending in the long side direction of the element body 10, and thus interference with the electrode 20 can be avoided and a large formation region can be ensured. When the formation region of the two-dimensional code 30 is large, the number of cells for the two-dimensional code 30 can be increased, that is, the number of digits of information can be increased, and thus the two-dimensional code 30 can include more information.

The individual body ID may be an ID which can be identified among a plurality of multilayer chip components 1 which can be obtained from one laminate substrate 54 or may be a completely unique ID which can be identified regardless of the laminate substrate 54 from which it is obtained.

The information identifying an intermediate product indicated by the two-dimensional code 30 is not limited to the substrate ID and may be the sheet ID or the sheet roll ID. In addition, the information identifying an intermediate product indicated by the two-dimensional code 30 may be a plurality of pieces of information of the substrate ID, the sheet ID, and the sheet roll ID. When the two-dimensional code 30 ID indicates information identifying a plurality of intermediate products, it is possible to more accurately and more quickly discern an intermediate product, and thus higher traceability can be achieved.

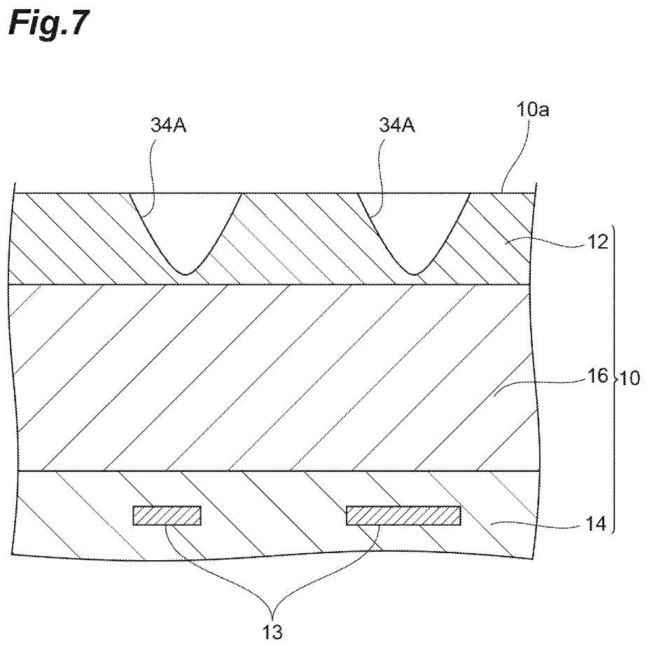

Since the dots 34 have substantially a semicircular cross-sectional shape, a corner portion in which stress is likely to be concentrated is not present on an inner surface thereof, and thus a situation in which cracking is propagated from the inner surfaces of the dots 34 is effectively curbed. The dots 34 can be variously deformed as long as they have substantially a semicircular cross-sectional shape. For example, as illustrated in FIG. 7, dots 34A having a parabolic cross-sectional shape may be adopted. Inner surfaces of the dots 34A are constituted of only a flat surface and a curved surface, and thus substantially no corner portions are present on the inner surfaces of the dots 34A.

The present disclosure is not limited to the embodiment described above and can be variously modified. For example, the green sheets are not limited to glass, and other dielectric materials, magnetic materials, or the like may be adopted. in addition, the code may be a one-dimensional code (bar code). The code may include lines constituted of dots adjacent to each other in addition to dots. The dots may have a polygonal shape in a plan view, for example, and may also have a square shape, for example, The dots are not limited to recesses formed through laser processing and may be formed of a thin film using a printing technology.

What is claimed is:

1. A method of manufacturing a multilayer chip component comprising:
a step of forming a code in each of a plurality of individual regions on a main surface of a laminate substrate, a plurality of green sheets are laminated in the laminate substrate, the code indicates at least information identifying an intermediate product in a previous stage and information identifying an individual finished product;
a step of forming a plurality of green chips by dividing the laminate substrate according to each of the individual regions; and
a step of making each of the green chips into a multilayer chip component as a finished product.

2. The method of manufacturing a multilayer chip component according to claim 1,
wherein after the code is formed in a green sheet constituting the main surface of the laminate substrate, the laminate substrate is obtained by laminating a plurality of green sheets including the green sheet constituting the main surface of the laminate substrate.

3. The method of manufacturing a multilayer chip component according to claim 1,
wherein the information identifying an intermediate product in a previous stage is information identifying the laminate substrate.

4. The method of manufacturing a multilayer chip component according to claim 1,
wherein the code is a two-dimensional code including a plurality of dots.

5. The method of manufacturing a multilayer chip component according to claim 4,
wherein in the step of forming a code, the dots included in the code are formed through laser processing.
